(19) United States
(12) Patent Application Publication
(10) Pub. No.: US 2024/0229407 A1
(43) Pub. Date: Jul. 11, 2024

(54) FOUNDATION FOR A WIND TURBINE

(71) Applicant: UNIVERSELLE-FERTIGTEIL-FUNDAMENTE GMBH, Hamburg (DE)

(72) Inventors: Gregor PRASS, Hamburg (DE); Christoph SCHRIEFER, Redefin (DE)

(21) Appl. No.: 17/045,167

(22) PCT Filed: Apr. 10, 2019
(86) PCT No.: PCT/EP2019/059135

§ 371 Date: Jun. 29, 2021

(30) Foreign Application Priority Data
Apr. 16, 2018 (DE) 10 2018 109 009.9
Mar. 27, 2019 (DE) 10 2019 107 960.8

(51) Int. Cl. E02D 27/42; F03D 13/20

(52) U.S. Cl. CPC E02D 27/425; F03D 13/206

(57) ABSTRACT

The invention relates to the foundation for a wind turbine, wherein the foundation (10) comprises essentially prefabricated elements, preferably made from reinforced concrete, having a first, vertically extending base-like section (11) on which a tower of the wind turbine can be mounted. Also comprising a second essentially horizontally extending section (12) designed as the foundation body which is in contact with the ground (100). The first section (11) is mounted above the second section (12) and comprises at least one closed base element (14), preferably sleeve-shaped that is either annular or polygonal, and the second section (12) is formed from at least two horizontal elements (22) that have a support section (25) for the first section (11), preferably base-like, which is divided into at least two partial regions (29, 30) by a recess (33), preferably accessible, provided between the partial regions (29, 30) and from which at least one is holdingly connected to the first section (11) thereover.

The invention relates to a foundation for a wind turbine, wherein the foundation comprises essentially prefabricated elements, preferably made from reinforced concrete, with a first section, extending vertically and taking the form of a pedestal, on which a tower of the wind turbine can be arranged, and a second section, extending essentially horizontally, as a foundation body which is in contact with the ground, wherein the first section is arranged above the second section and comprises at least one closed pedestal element, preferably in the form of a sleeve, which has an annular or polygonal design, and wherein the second section is formed from at least two horizontal elements, and to a method for its production.

Foundations for wind turbines are essentially designed as in situ concrete foundations. For this purpose, a pit is dug which is provided with a blinding layer. The formwork and the reinforcement are then erected and the whole is filled with concrete on site. A flat body, which may have a pedestal, is thus established (see, for example, US 20160369520 A1 or WO 2008/036934 A2). In addition to the transport cost of delivering the concrete, the formwork, and the reinforcement, this is a very labor-intensive process on site. Also, quality assurance is complicated or problematic depending on the weather conditions. Furthermore, dismantling once the wind turbine has reached the end of its life is expensive and very complicated. This is particularly the case for concrete towers for wind turbines which optimally have a diameter to height ratio of approximately 1:10, as a result of which diameters of 8 to 15 m are not uncommon. Foundations for such towers have until now been produced using in situ concrete. Areas must furthermore be provided in which the pretensioning elements of the tower can be attached and pretensioned to the foundation. The pretensioning is effected with devices provided for this purpose which have to be placed in the pretensioning areas. Usually complicated cantilever structures, below which the devices are then placed, are provided inside the foundation as an abutment for pretensioning or attaching the pretensioning elements (strands/cables). These structures are complex and in need of improvement.

There is furthermore in principle a need to erect foundations of wind turbines from prefabricated elements, whereby the abovementioned problems can be reduced or eliminated. It is in principle advantageous that, when they are prefabricated, the components can be produced in a standardized fashion under defined conditions. The on site labor costs are also reduced. Different approaches to doing this have been described in the prior art.

For example, WO 2008/036934 A2 discloses a combination of prefabricated elements and conventional formwork/reinforcement construction. As a result, the abovementioned disadvantages are reduced only marginally.

Other approaches to producing foundations for wind turbines from prefabricated components are shown in the prior art as follows:

EP 1058787 B1 discloses a foundation for a wind turbine in order to erect offshore wind turbines which are transported completely pre-assembled, i.e. including the foundation, and are set down at the erection site on the sea bed in one piece. The foundation here comprises individual prefabricated segments. These can be made from concrete. A flat section and a pedestal section are disclosed. The pedestal section consists of circular rings. The flat section consists of individual trapezoidal base elements in the base surface and on which the pedestal section is mounted vertically at the inner end, which has vertical passages. The flat base sections are connected to one another by means of tongue-and-groove joints. The pedestal section and the flat base section are connected to a diagonal strut to stiffen them. The circular segments of the pedestal section likewise have vertical passages. Connecting cables/anchor rods are inserted into the passages. If the foundation parts are provided from concrete, a flat steel abutment ring is provided below the base elements in the region of the vertical passages. The foundation is assembled and the wind turbine fastened on the foundation by the connecting cables/anchor rods. In addition, horizontal passages are provided in base elements and diagonal struts, in which connecting cables/anchor rods by means of which the elements of the foundation are pretensioned horizontally are likewise arranged. Only when it has been pretensioned horizontally is the foundation completed such that it can withstand stresses. EP 1 058 787 B1 thus discloses a foundation consisting of individual prefabricated concrete parts, with a flat section and a pedestal section, wherein at least these two sections are connected to each other vertically and horizontally.

A disadvantage hereby is that considerable costs and a considerable labor effort are required to connect the elements and produce the foundation which is capable of absorbing static loads.

EP 1 074 663 A1 discloses a foundation for a wind turbine with a central body as a pedestal with laterally extending ribs/projections/brackets arranged in a star shape and bolted thereto. The ribs and the central body are bolted together horizontally on site. The parts are manufactured, inter alia, from concrete and are delivered to the erection site by a truck, arranged by a crane, and bolted together horizontally on site via flanges and bolts. Moreover, anchors are required on the outside of the ribs in order to ensure sufficient load transfer.

It is a disadvantage hereby that here too considerable costs and considerable labor effort are required to connect the elements and produce the foundation which is capable of absorbing static loads. Additional anchoring means are also required.

WO 2004/101898 A2 discloses a foundation for a wind turbine made from prefabricated individual concrete parts, wherein either a central body is provided to which flat bodies are bolted horizontally or the foundation consists solely of components which have both a flat section and a pedestal-like section, wherein these are then connected together horizontally by being bolted against flanges.

It is a disadvantage hereby that here too considerable costs and considerable labor effort are required to connect the elements and produce the foundation which is capable of absorbing static loads.

EP 2182201 A1 discloses two different foundations for a wind turbine. In both cases, a foundation is erected on site from prefabricated concrete parts after corresponding delivery. Both have a flat section and a pedestal-like section. In the first variant, a central body is provided. The ribs/flat elements are placed on the latter. When mounted, the ribs form a polygonal body. The central body has a projection which is gripped by a corresponding recess on the ribs. The ribs are additionally locked against the central body by means of a lashing ring. Anchor rods for mounting the tower are provided on the flat bodies. In the second variant, the ribs have horizontally projecting anchor elements which, when mounted, extend radially into the center of the foundation. Plates are provided below and above the anchors. The in situ concrete is introduced into the cavity thus formed in order to connect the anchors to one another and form a central body. In both variants, horizontal connection is simplified. However, both the ribs and the central body have dimensions and weights which make transport complicated.

WO 2017/141095 A1 and WO 2017/141098 A1 likewise disclose a foundation for a wind turbine. This foundation is formed from prefabricated rib bodies which have at their inner end a pedestal section on which the tower of the wind turbine is arranged. The ribs extend outward in a star shape. In a further embodiment, the sections between the ribs are filled with plate elements which are bolted against the ribs via flanges in order to produce a plate. In the center, instead of a central body, a steel sleeve is provided which is connected to reinforcements provided inside the ribs and reinforcing beams provided in the inner cavity. The ribs have a base plate on which a diagonal reinforcing element and the pedestal section are arranged as a single piece. The pedestal sections are connected to one another horizontally via tongue-and-groove elements. The pedestal sections furthermore have horizontal openings in which tensioning elements are provided for the purpose of horizontally connecting the pedestal sections. Anchor rods for connecting the tower to the foundation are furthermore embedded in the pedestal sections. Ground anchors which are likewise situated on the outside are furthermore disclosed.

It is a disadvantage hereby that here too considerable costs and considerable labor effort are required to connect the elements and produce the foundation which is capable of absorbing static loads.

The object of the invention is therefore to overcome the abovementioned disadvantages and to make it possible to economically erect foundations for wind turbines, in particular for wind turbines with concrete towers, from prefabricated elements.

The object according to the invention is achieved according to a first solution by the horizontal elements having a bearing section for the first section, preferably in the manner of a pedestal, which is divided into at least two part regions by a recess provided between the part regions, preferably movably, at least one of which is connected to the first section arranged thereabove so that it is retained.

As a result, a foundation can be provided in a particularly simple fashion which can be connected to the tower, preferably to a concrete tower.

A further teaching of the invention provides that the recess is arranged below a hole in the first section for the passage of a pretensioning element of the tower of the wind turbine. A further teaching of the invention provides that the first part region is provided at the front inner end of the horizontal element. As a result, the pretensioning can be provided in a particularly simple fashion.

The object according to the invention is achieved according to a second solution by the second section being formed from at least three horizontal elements, and by it being possible for the horizontal elements to be arranged depending on the parameters of the tower to be erected. A further teaching provides that the horizontal elements are arranged spaced apart from one another laterally, or that the horizontal elements are arranged spaced apart from one another laterally in parallel. It is furthermore advantageous if structurally similar horizontal elements are used. As a result, it is particularly simply possible to provide a foundation depending on the dimensions of the tower to be erected. It is in particular possible to build foundations for different tower radii using a type of horizontal element by the horizontal elements being shifted appropriately in parallel, as is shown in particular in the preferred exemplary embodiment.

A further teaching of the invention provides that the first section has just one closed pedestal element. It is advantageous hereby that the pedestal element is cast at least partially in formwork on site. It is furthermore advantageous that connecting means, which are embedded in order to produce a connection to the pedestal element, are provided in the horizontal elements. The pedestal element can in this way be produced cost-effectively. At the same time, it is possible to reduce the transport costs with respect to the pedestal.

A further teaching of the invention provides that the pedestal element is at least partially built from prefabricated semi-finished concrete parts which are cast using in situ concrete. As a result, the labor effort required when building the formwork can be further reduced. In this way, the pedestal element can therefore be produced cost-effectively. At the same time, it is possible to reduce the transport costs with respect to the pedestal.

A further teaching of the invention provides that the at least one pedestal element of the first section has at least one essentially vertical hole in which an essentially vertical tensioning element, pretensioning element, reinforcing element, or anchor element, preferably a threaded rod, is arranged. As a result, it is possible in a particularly simple manner to provide the foundation cost-effectively and quickly.

A further teaching of the invention provides that the bearing section of the horizontal element of the second section has at least one essentially vertical hole which, when mounted, is aligned with the at least one essentially vertical hole of the at least one pedestal element of the first section. As a result, it is possible in a particularly simple manner to provide the foundation cost-effectively and quickly.

A further teaching of the invention provides that the at least one pedestal element of the first section and the at least two horizontal elements of the second section are connected to one another by the essentially vertical tensioning element, pretensioning element, reinforcing element, or anchor element, in such a way that no further fastening means, in particular horizontal fastening means, are required for the transfer of the loads of the wind turbine. It has surprisingly been shown that it is thus possible in a simple manner to omit horizontal connecting means.

A further teaching of the invention provides that at least one abutment, against which the essentially vertical tensioning elements are arranged and tensioned, is provided below or inside the second section, and/or that an abutment, against which the essentially vertical tensioning elements are arranged and tensioned, is provided above or inside the first section, wherein the upper abutment is preferably a flange of the tower of the wind turbine. As a result, it is possible in a similar manner to ensure reliable tensioning and pretensioning.

A further teaching of the invention provides that the closed pedestal element of the first section is composed of at least two segments. As a result, it is possible to allow simple transport even at sizes which would only be possible using special transport arrangements or would not be possible at all.

A further teaching of the invention provides that a further section which takes the form of a pedestal is provided which is arranged below the second section and has at least one closed pedestal element, preferably in the form of a sleeve, and that the further section is required for the transfer of the loads of the wind turbine.

A further teaching of the invention provides that the closed pedestal element of the first section and/or of the further section is composed of at least two segments, wherein a connecting region is provided between the segments. As a result, it is possible to allow simple transport even at sizes which would only be possible using special transport arrangements or would not be possible at all.

A further teaching of the invention provides that the segments overlap in the connecting region, wherein the holes also overlap in the overlap region. As a result, it is possible to allow transport even at sizes which would only be possible using special transport arrangements or would not be possible at all.

A further teaching of the invention provides that the segments in the connecting region adjoin each other via essentially vertical contact faces, wherein gaps are preferably provided between the contact faces. A further teaching of the invention provides that in the connecting region essentially horizontal reinforcing elements protrude from the segments which overlap in the connecting region. As a result, a simple and reliable connection can be provided.

A further teaching of the invention provides that the segments in the connecting region taper with regard to the height of the segments and/or the width of the segments, wherein holes are preferably provided in the tapered sections. A further teaching of the invention provides that the horizontal reinforcing elements overlap in the tapered sections. A further teaching of the invention provides that the connecting region and/or tapered region is filled with a mortar or in situ concrete. It has surprisingly been shown that, as a result, a particularly durable and cost-effective connection is provided when segments are provided.

A further teaching of the invention, with respect to all the teachings of the invention, provides that the vertical and horizontal joints between the elements are realized by vertical and/or horizontal spacers being arranged between the elements. A further teaching of the invention, with respect to all the teachings of the invention, provides that vertical and horizontal joints between the elements are at least partially filled with a mortar. As a result, the stability of the foundation is assisted because the other measures are assisted by providing a monolithic connection.

The object is furthermore achieved by a method for producing a foundation for a wind turbine, in particular an above described foundation, wherein the foundation is built essentially from prefabricated elements, preferably from reinforced concrete, wherein an essentially horizontally extending section is provided as a foundation body in contact with the ground and on which a vertically extending section, which takes the form of a pedestal, is arranged which is provided as a closed pedestal element, preferably in the form of a sleeve, which has an annular or polygonal design, wherein the horizontal section is formed from at least three horizontal elements, and that the horizontal elements are arranged depending on the parameters of the tower which is to be erected.

It is advantageous here that the horizontal elements are arranged spaced apart from one another laterally, or that the horizontal elements are arranged spaced apart from one another laterally in parallel.

It is furthermore advantageous that the section which takes the form of a pedestal is built on the essentially horizontally extending section by formwork with reinforcement and/or at least partially prefabricated semi-finished concrete parts being provided into which in situ concrete is then poured. As a result, the labor effort required to build the formwork can be further reduced. In this way, the pedestal element can therefore be produced cost-effectively. At the same time, it is possible to reduce the transport costs with respect to the pedestal.

As a result, the foundations can be erected in a particularly simple manner, in particular if only one type of horizontal element is used.

The invention is explained in detail below with the aid of exemplary embodiments in conjunction with drawings, in which:

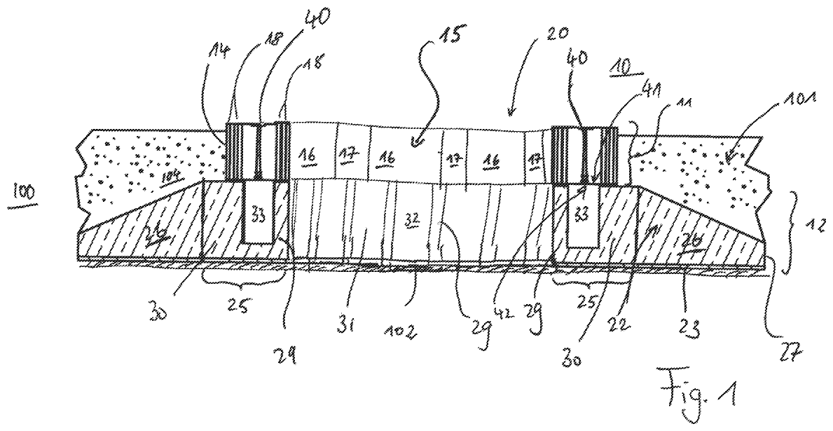

FIGS. 1 to 6 show views and details of a first embodiment of a foundation according to the invention,

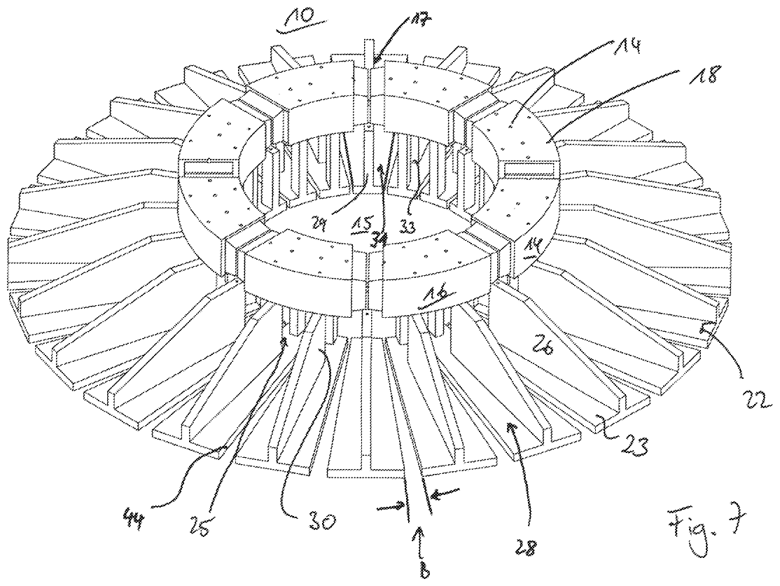

FIGS. 7 to 11 show views and details of a second embodiment of a foundation according to the invention,

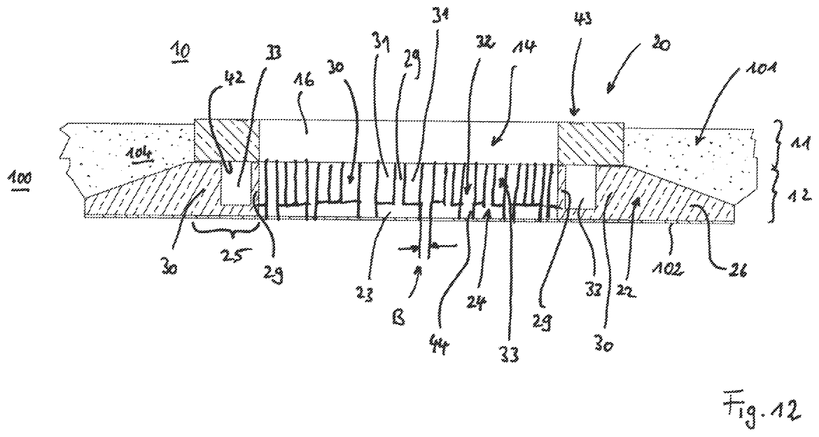

FIGS. 12 to 19d show views and details of a third embodiment of a foundation according to the invention, and

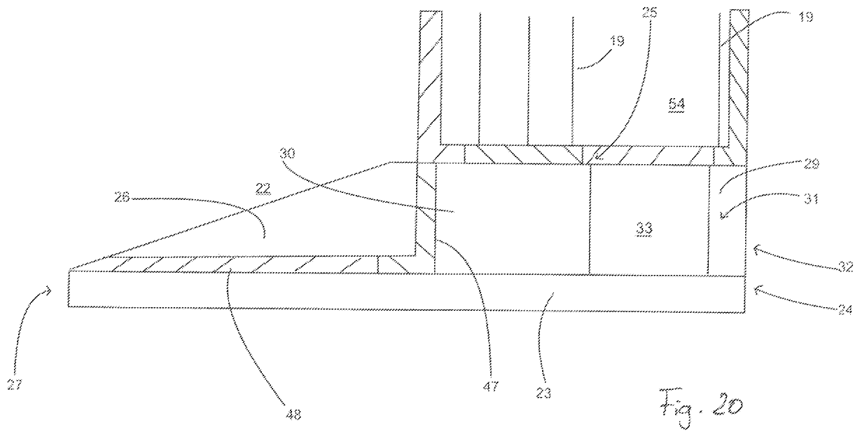

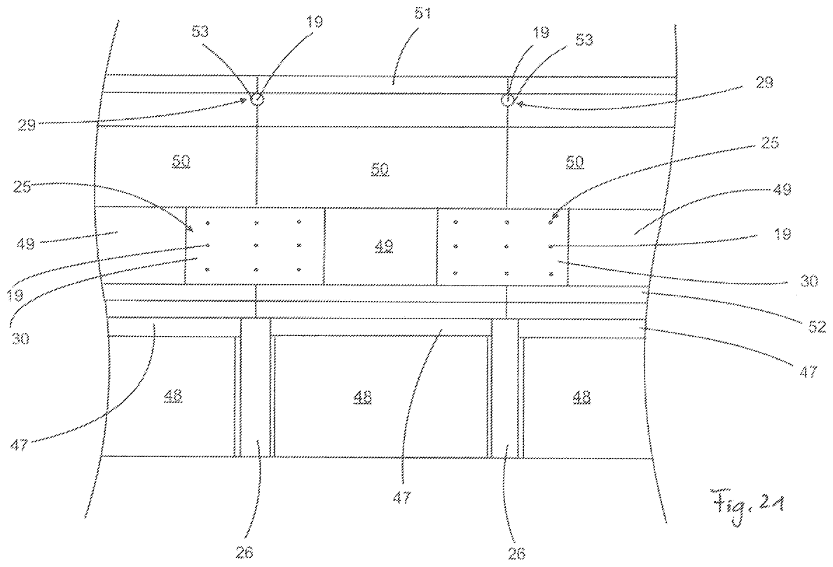

FIG. 20 and FIG. 21 show an amendment to the third embodiment in FIGS. 12 to 19d.

FIGS. 1 to 6, FIGS. 7 to 11, and FIGS. 12 to 19d show a first, a second, and a third embodiment of a foundation 10 according to the invention. The same constituent parts have the same reference symbols.

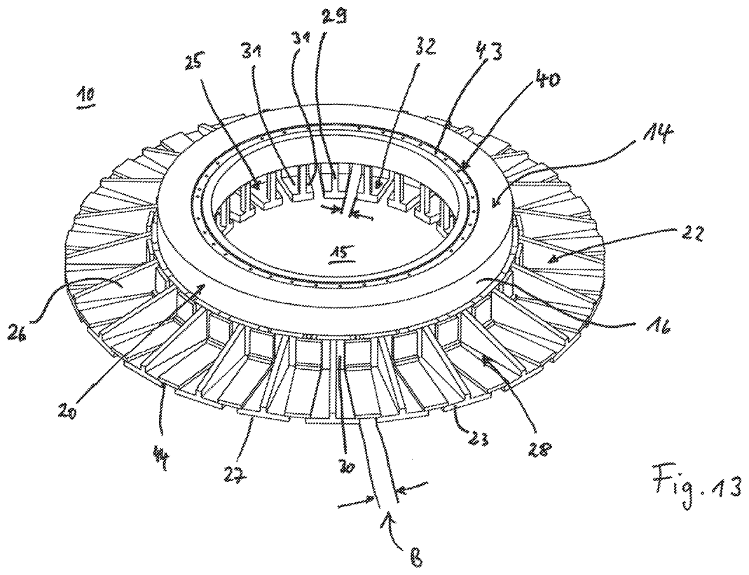

In FIG. 1 and FIG. 13, in a view in cross-section, in each case an embodiment of a foundation 10 is arranged in a pit 101 in the ground 100 on top of a blinding layer 102. They have a first section 11 and a second section 12. A third section (not shown) can furthermore also optionally be provided below the second section 12, preferably provided in a depression (not shown).

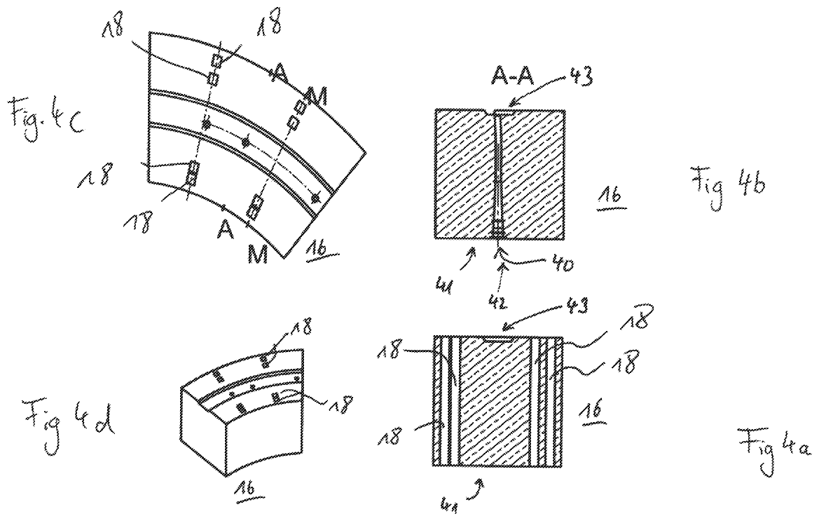

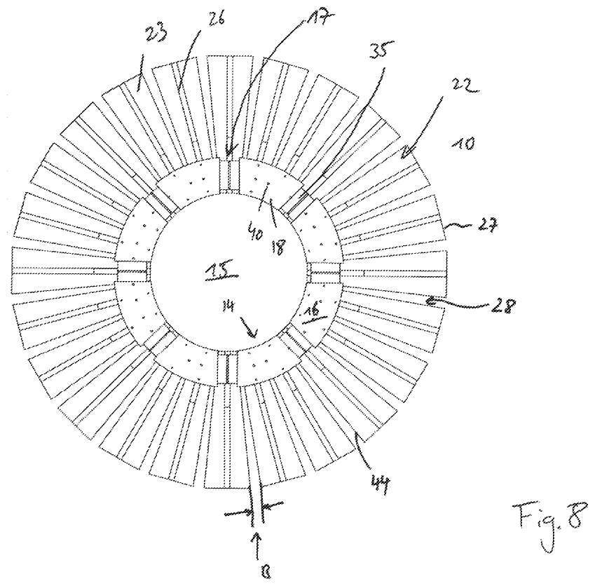

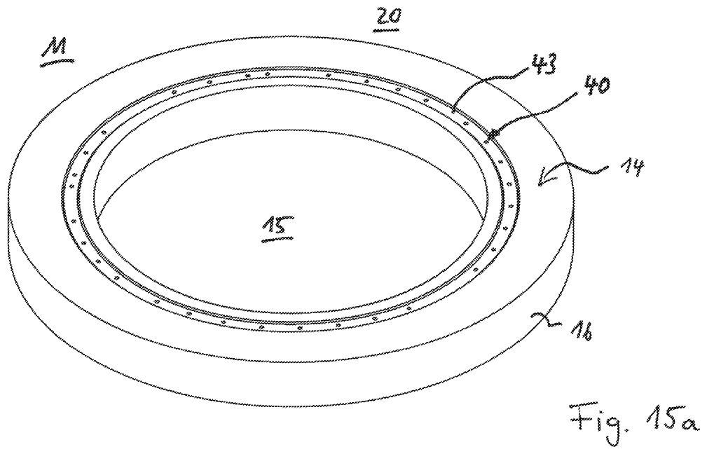

The first section 11 is constructed as a pedestal 20 consisting of one or more closed pedestal elements 14 (see FIGS. 4a to 4d/FIGS. 9a, 9b/FIGS. 15a, 15b) which preferably take the form of circular rings such that the pedestal section 11 has an internal space 15. According to the first and second embodiment shown, the pedestal elements 14 have vertical holes 18 in which anchor or reinforcing rods 19 are provided after the foundation 10 has been assembled in order to fasten, tension, or pretension the foundation 10.

The pedestal elements 14 are formed from at least one segment 16.

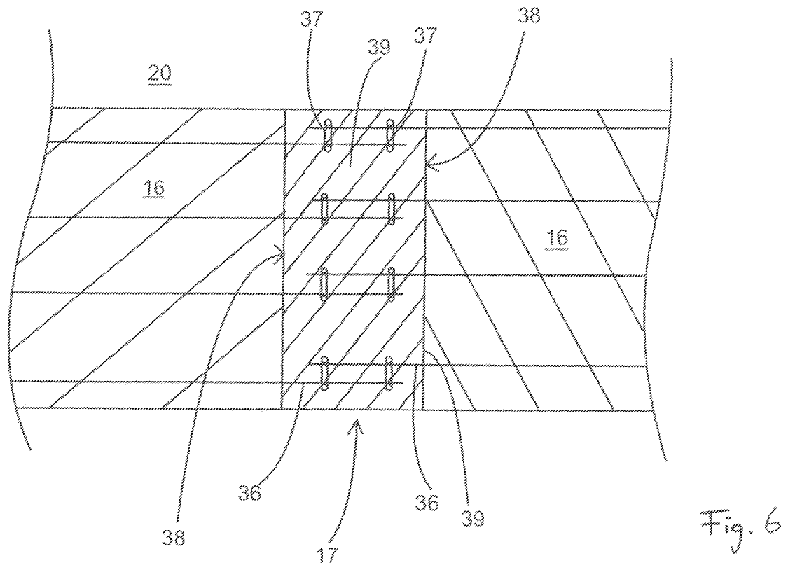

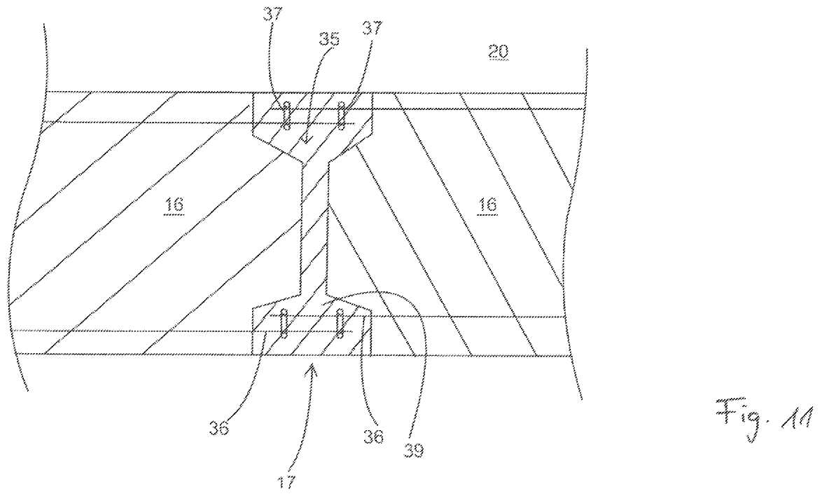

If multiple segments 16 are provided, the segments 16 have a connecting region 17 which is formed such that the segments 16 have vertical end faces 38 from which reinforcing elements 36 protrude (see FIG. 6, FIG. 11) which are connected to one another via connecting means 37. The connecting region 17 is then filled with in situ concrete or mortar 39.

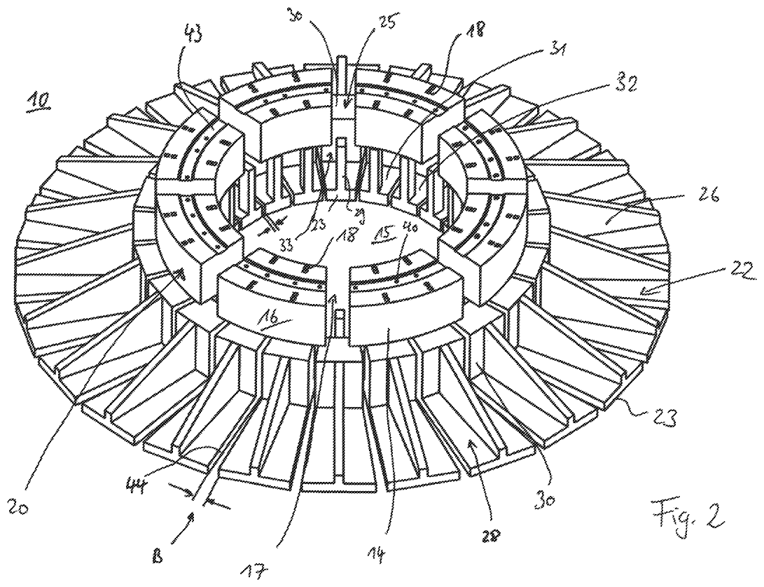

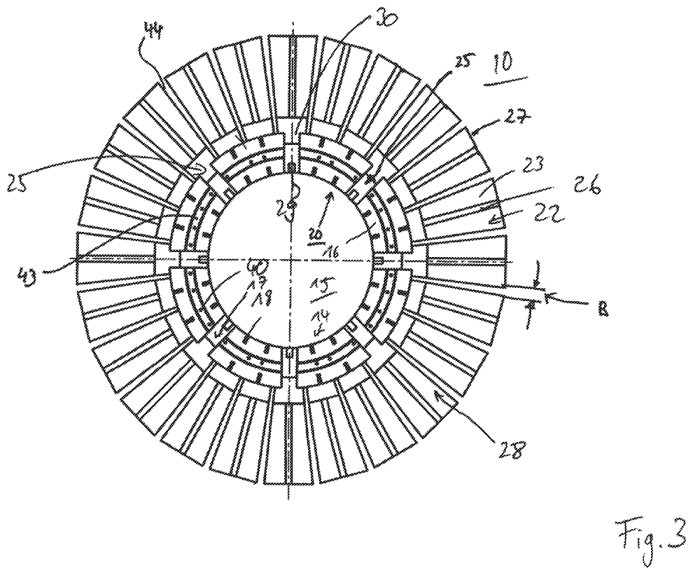

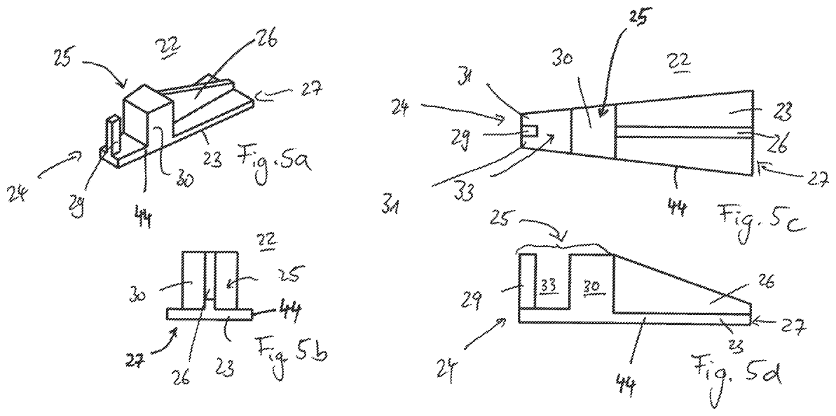

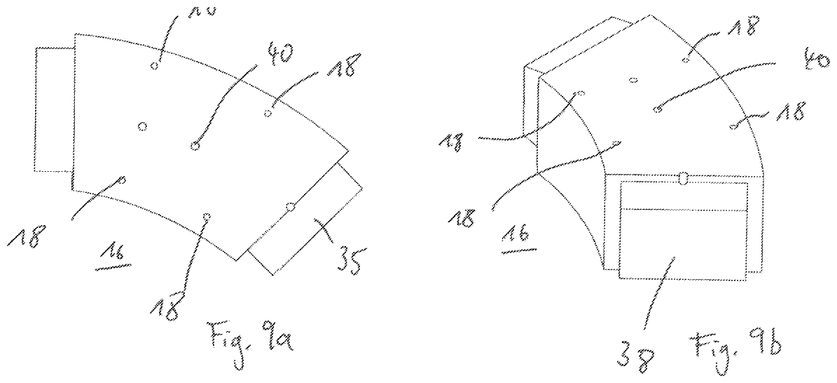

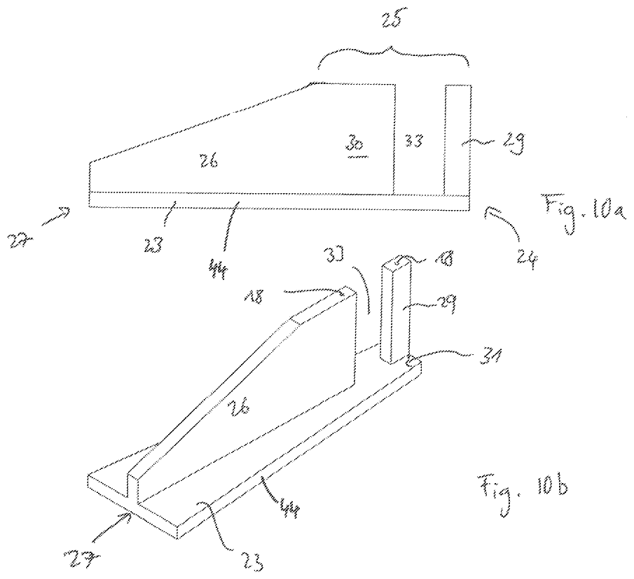

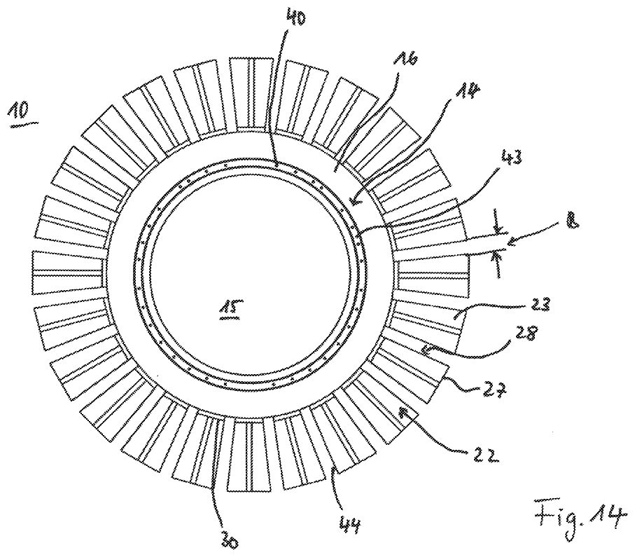

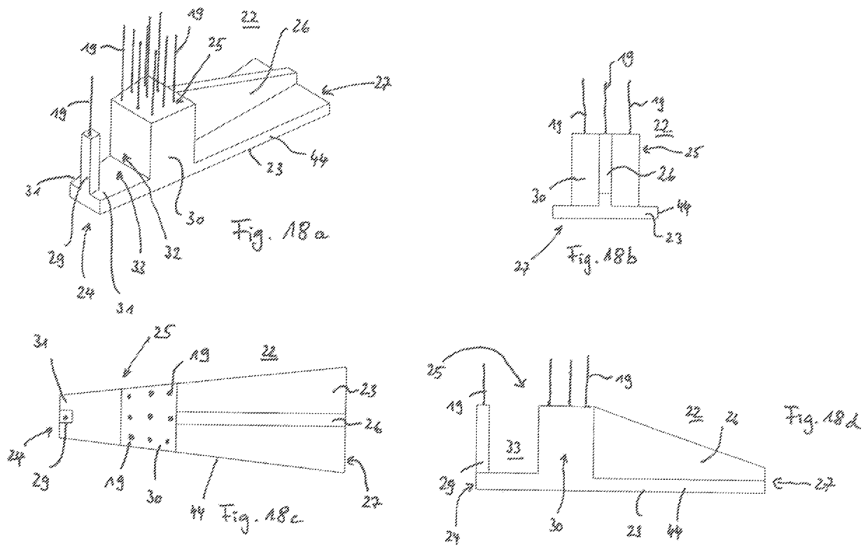

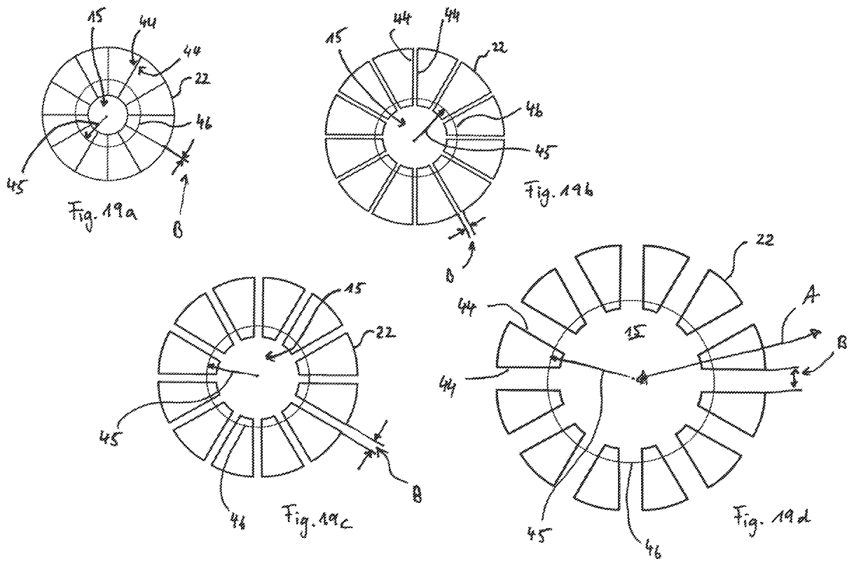

The second section 12 has a flat design. Alternatively, however, it can also be star-shaped. A plan view of the foundation 10 is shown in FIG. 3/FIG. 8/FIG. 14. FIG. 2/FIG. 7/FIG. 13 show a three-dimensional view of the foundation 10. The second section 12 is configured from horizontal elements 22 in the form of rib elements which are illustrated in FIGS. 5a to 5d/FIGS. 10a, 10b/FIGS. 18a to 18d. They extend radially outward, viewed from the internal space 15. They have a base plate 23, which for example has a trapezoidal design, such that all the assembled base plates form a polygonal surface (see FIG. 3) which has an approximate circular shape. Alternatively, segments of a circle (see FIGS. 19a to 19d) or a mix of segments of a circle and trapezoidal shapes are also possible. Gaps B can preferably be provided between side walls 44 of the base plates 23 which depend on the diameter of the tower to be erected.

A bearing section 25, which corresponds essentially preferably with the pedestal 20 of the first section 11, is provided on the inner end 24 of the base plate 23. Holes 18 can likewise be provided in the bearing section 25. Alternatively, reinforcing bars or anchor rods 19 (FIGS. 18a to 18d) which extend outward from the concrete of the pedestal-like section 25 of the horizontal element 22 can be installed in the bearing section 25, for example in the first and second bearing section 29, 30, aligned with the holes 18 in the first section 11. The pedestal 20 is arranged on the bearing section 25 by its at least one pedestal element 14.

The bearing section 25 is here preferably divided into two bearing sections 29, 30. A recess 33, which is preferably designed to be movable, is provided between the bearing sections 29, 30. The first bearing section 29 is provided on the inner end 24 of the horizontal element 22. It takes the form here of a narrow column in the embodiments. Once the foundation has been assembled, the exposed regions 31 to the right and left form a gap 32 in order to provide access to the recess 33. The second bearing section 30 is illustrated in the first and third embodiment in the manner of a pedestal and in the second embodiment as a component part of a stiffening wall 26. As shown in FIGS. 10a, 10b, holes 18 can furthermore be provided.

The stiffening wall 26, the height of which reduces, for example, in the direction of the outer end 27 of the base plate 23, is arranged at right angles on the base plate. A cavity 28, open on the upper side and into which infill soil 104 can be poured is formed between two adjacent stiffening walls 26, as a result of which a load can be applied to the second section 12 of the foundation 10.

Spacers (not shown) can be arranged between the elements 14, 16, 22, 30 in order to enable/simplify the filling of the joints with mortar.

A further connection of the segments 16 is illustrated in FIG. 11. The segments are arranged by being butted up against one another. However, the segments 16 taper in a connecting region 17. Reinforcing elements 36 protrude horizontally from the segments 16 in the tapered region 35. When arranged ready for assembly, the reinforcing elements 36 of the adjacent segments 16 are aligned and overlap in the connecting region 17/tapered region 35. They are connected to one another by connecting means 37 which are illustrated purely schematically in FIG. 11. When necessary, the segments 16 also have holes 18 in the tapered regions 35 but these are not illustrated in FIG. 11. The tapered regions 35 are filled with mortar 39 or in situ concrete after connecting the reinforcing elements 36, as a result of which the segments are additionally connected to one another monolithically/by being materially bonded, which results in a particularly stable connection of the segments 16. It is particularly advantageous here that the overlap region can be significantly shorter due to the provision of the tapers. The required amount of mortar 39 is furthermore considerably reduced. This makes it cost-efficient to use faster setting mortars or in situ concrete, as a result of which foundations can be assembled more quickly. The same is shown in FIG. 6 without tapered regions 36 but with plane end walls 38.

The segments 16 are preferably provided in the center (depending on the arrangement of the tensioning elements of the tower) with holes 40 through which the pretensioning elements of the tower are passed. The underside 41 of the segment 16 then serves as an abutment for the pretensioning elements. The recesses 33 are arranged such that they are situated below the lower end 42 of the holes 40 such that they can be reached for pretensioning. Depressions 43 can furthermore be provided on the segments. They can serve for the arrangement of means for connection to the tower.

A third section (not illustrated) can be provided below the second section 12. It serves to stiffen the foundation 10. It has been shown that it is possible, in particular in the case of large pedestal diameters, to provide just the third section 13 in order to achieve a sufficient load transfer.

The third section (not illustrated) is furthermore also at the same time, when necessary, an abutment via its lowermost pedestal element (not illustrated) for fastening elements 31 of the anchor rods 19 during pretensioning. Two pedestal elements 14, which are formed from segments 16 which are here again arranged by being butted up against one another, can, for example, be provided. Alternatively, further pedestal elements 14 can also be provided. A depression (not illustrated), into which the fastening elements (not illustrated) can engage, or into which abutment elements (not illustrated) can be arranged, can be provided in the lowermost pedestal element 14d.

A cavity (not illustrated), into which the anchor rods/threaded rods 19 or other alternative fastening means (cables, etc) open and onto which the, for example, nuts are screwed as fastening means (not illustrated) in the form of locking and pretensioning means, is provided below the third section (not illustrated). For protection against corrosion of the fastening means, the cavity (not illustrated) is filled with in situ concrete.

As illustrated in FIGS. 19a to 19d, it is possible to form a second section which has an internal space 15 of different sizes with a horizontal element 22 by the horizontal elements 22 being shifted inward or outward along a line radiating from the center, as illustrated in FIG. 19d by the double-ended arrow A. This movement is limited inwardly by the side faces 44 of the base plates 23 of the horizontal elements 23 contacting each other. It depends outwardly on the radius 45 of the tower which is to be erected, which is illustrated in FIGS. 19a to 19d by a circle 46. The gap B is preferably the same over the whole length of the side faces 44 from the inner end 24 to the outer end 27 such that two side faces 44 are arranged parallel to each other. As a result, foundations for towers with different diameters can preferably be easily erected with a single horizontal element 22.

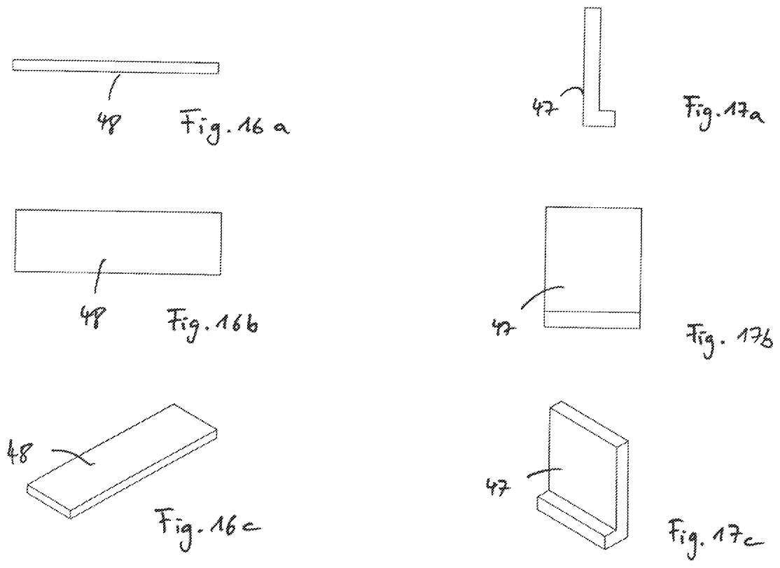

So that the cavities 28 can be filled with infill soil 104 and the latter cannot enter the internal space 15, L-shaped elements 47 (FIG. 17a to FIG. 17c) are omitted, which are placed against the second bearing section 30, as illustrated in FIG. 13.

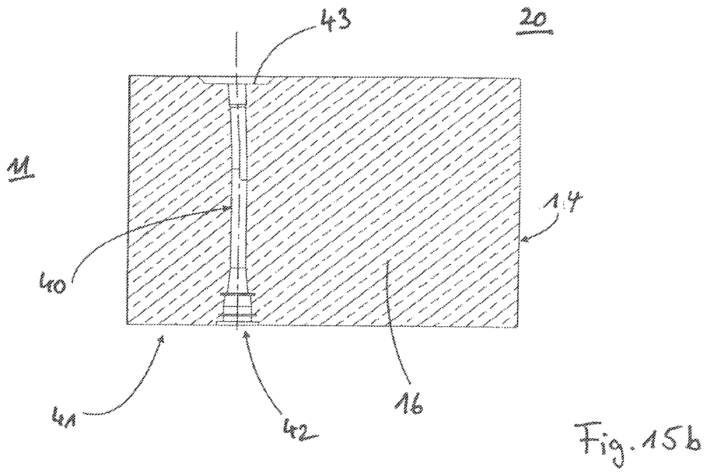

Cover plates (FIG. 16a to FIG. 16c) are furthermore provided which are placed on two adjacent base plates 23 in order to cover the gap B between two side faces 44 so that the soil cannot pass into the gap B or through the gap B. By virtue of the cover plate 48, the full load of the infill soil 104 can be applied to the second section by being poured into the cavity 28.

As an alternative to a prefabricated pedestal element 14 or prefabricated segments 16 which are assembled on site to form a pedestal element 14, the pedestal element can also be produced, as illustrated in the third embodiment, by means of formwork (not illustrated), reinforcement (not illustrated), and the in situ pouring of in situ concrete on site onto the bearing region 25.

For this purpose, formwork (not illustrated) is erected on the bearing section 25 in accordance with a formwork plan. The anchor rods 19 provided in the horizontal elements 22 or which can be inserted therein into the holes 18 project into this formwork. The anchor rods 19 are incorporated into the reinforcement (not illustrated) which is to be provided in the formwork in accordance with a reinforcement plan. In situ concrete is then poured in. After it has set, the pedestal element 14 is connected to the second section 12 and the tower can be erected.

Another alternative for building the pedestal element 14 of the foundation 10 according to the invention is shown in FIGS. 20, 21. As an alternative to the formwork (not illustrated) or partially replacing it here (likewise not illustrated), prefabricated semi-finished concrete parts are provided as plates 49 and 50. The latter bear on the bearing section 29, 30 and thus essentially form, together with the bearing sections 29, 30 from which the anchor rods project, the underside of the pedestal element 15. L-shaped elements 41 for the inside of the pedestal element 15, and 52 for the outside of the pedestal element 15, are furthermore provided. They likewise bear on the bearing section 29, 30.

The semi-finished concrete parts 49, 50, 51, 52 contain reinforcement and are furthermore provided with reinforcement (not illustrated) which extends to the outside.

The semi-finished concrete parts 49, 50, 51, 52 can furthermore have recesses 53 for the anchor rods 19 and/or the holes 40.

Once the semi-finished concrete parts 49, 50, 51, 52 have been completely arranged, they preferably form a trough 54 into which the in situ concrete is poured. Further reinforcement can, for example, additionally be provided in the trough in order to increase the stiffness of the pedestal element 15.

Combinations of formwork and semi-finished concrete parts 49, 50, 51, 52 are also possible.

After setting, the pedestal element 14 is connected to the second section 12 and the tower can be erected thereon.

List of reference symbols

| | |
|---|---|
| 10 | foundation |
| 11 | first section/pedestal section |
| 12 | second section |
| 14 | pedestal element |
| 15 | internal space |
| 16 | segment |
| 17 | connecting region |
| 18 | hole |
| 19 | anchor rods |
| 20 | pedestal |
| 21 | step section |
| 22 | horizontal element/rib element |
| 23 | base plate |
| 24 | inner end |
| 25 | bearing section |
| 26 | stiffening wall |
| 27 | outer end |
| 28 | cavity |
| 29 | first bearing section |
| 30 | second bearing section |
| 31 | exposed region |
| 32 | hole |
| 33 | recess |
| 35 | tapered region |
| 36 | reinforcing element |
| 37 | connecting means |
| 38 | end wall |
| 39 | mortar/in situ concrete |
| 40 | hole |
| 41 | underside |
| 42 | lower end |
| 43 | depression |
| 44 | side face |
| 45 | radius |
| 46 | circle |
| 47 | L-shaped element |
| 48 | cover plate |
| 49 | plate |
| 50 | plate |
| 51 | L-shaped element |
| 52 | L-shaped element |
| 53 | recess |
| 54 | trough |
| 100 | ground |
| 101 | excavation pit |
| 102 | blinding layer |
| 104 | infill soil |
| A | direction of shifting |
| B | gap |
| | ***** |

1-29. (canceled)

30. A method for producing a foundation for a wind turbine, wherein the foundation comprises prefabricated elements of reinforced concrete, with a first pedestal section extending vertically on which a tower of the wind turbine can be arranged, and a second section extending horizontally, as a foundation body which is in contact with the ground, wherein the first section is arranged above the second section and comprises at least one pedestal element, which has a closed annular or polygonal design, and wherein the second section is formed from a plurality of horizontal elements, configured whereby a predetermined number of horizontal elements are positioned along radial lines radiating horizontally from the center of the tower, essentially in contact with each other side to side for a predetermined minimum tower diameter, the method comprising
positioning the horizontal elements progressively father out on the radial lines for towers of larger diameter, thereby increasing the side to side separation of the horizontal elements;
wherein foundations for towers of different diameters may be produced from horizontal elements of the same design.

31. The method of claim 30 further comprising adding horizontal elements when the side to side separation exceeds a predetermined value, and redistributing the horizontal elements symmetrically along radial lines.

32. The method of claim 30, wherein the horizontal elements comprise a support section for the first section in the form of a pedestal, which is divided into at least two sub regions by a recess between the sub regions, further comprising connecting at least one of the two sub regions to the first section to retain the first section to the horizontal element.

33. The method of claim 32 wherein the recess is arranged below a hole in the first section wherein the hole is for a pretensioning element of the tower of the wind turbine.

34. The method of claim 32 wherein the first section is at the front inner end of the horizontal element.

35. The method of claim 30, wherein the at least one pedestal element of the first section has at least one vertical hole in which at least one of a vertical tensioning element, pretensioning element, reinforcing element, anchor element, or a threaded rod is arranged.

36. The method of claim 35, wherein the support section of the horizontal element of the second section has at least one vertical hole which is aligned with the at least one vertical hole of the at least one pedestal element of the first section when the first section is mounted to the second section.

37. The method of claim 35, wherein the at least one pedestal element of the first section and the at least two horizontal elements of the second section are connected to one another by the vertical tensioning element, pretensioning element, reinforcing element, or anchor element, in such a way that no further horizontal oriented fastening means are required for the transfer of the loads of the wind turbine.

38. The method of claim 35, wherein at least one abutment, against which the vertical tensioning elements are arranged and tensioned, is provided at least one of below or inside the second section, or above or inside the first section.

39. The method of claim 30, wherein a further section which takes the form of a pedestal is provided which is arranged below the second section and has at least one closed pedestal element and the further section is required for the transfer of the loads of the wind turbine.

40. The method of claim 39, wherein for the closed pedestal element, at least one of the first section or of the further section is comprised of at least two segments.

41. The method of claim 40, wherein the segments overlap in a connecting region, and wherein the holes also overlap in the overlap region.

42. The method of claim 40, wherein the segments in a connecting region adjoin each other via vertical contact faces, wherein gaps are provided between the contact faces.

43. The method of claim 40, wherein in a connecting region, horizontal reinforcing elements protrude from the segments which overlap in the connecting region.

44. The method of claim 30, wherein the first section consists of one closed pedestal element.

45. The method of claim 44, wherein the pedestal element is at least one of cast at least partially in formwork on site or at least partially built from prefabricated semi-finished concrete parts which are cast using in situ concrete.

46. The method of claim 44 wherein connecting means, which are embedded in order to produce a connection to the pedestal element, are provided in the horizontal elements.
